(19) United States
(12) Patent Application Publication
(10) Pub. No.: US 2014/0185183 A1
(43) Pub. Date: Jul. 3, 2014

(54) DIELECTRIC COMPOSITION AND MULTILAYER CERAMIC CAPACITOR USING THE SAME

(71) Applicant: SAMSUNG ELECTRO-MECHANICS CO., LTD., Suwon (KR)

(72) Inventors: Jae Sung PARK, Suwon (KR); Doo Young KIM, Suwon (KR); Jong Bong LIM, Suwon (KR); Chan Hee NAM, Suwon (KR); Seok Hyun YOON, Suwon (KR); Chang Hoon KIM, Suwon (KR)

(73) Assignee: SAMSUNG ELECTRO-MECHANICS CO., LTD., Suwon (KR)

(21) Appl. No.: 13/829,712

(22) Filed: Mar. 14, 2013

(30) Foreign Application Priority Data
Dec. 28, 2012 (KR) 10-2012-0155772

(51) Int. Cl. C04B 35/468; H01G 4/12

(52) U.S. Cl. CPC C04B 35/468; H01G 4/1218
USPC 361/301.4; 501/137

(57) ABSTRACT

There is provided a multilayer ceramic capacitor, including: a ceramic body including dielectric layers; first and second internal electrodes disposed to face each other with the dielectric layer interposed therebetween within the ceramic body; a first external electrode electrically connected to the first internal electrodes; and a second external electrode electrically connected to the second internal electrodes, wherein the dielectric layer includes 40 to 99 wt % of barium titanate (BaTiO₃) powder having an average grain size of 0.1 μm to 0.8 μm and 1 to 60 wt % of barium titanate zirconate (Ba(Ti₁₋ₓZrₓ)O₃) having an average grain size of 0.2 to 2.0 μm.

### CROSS-REFERENCE TO RELATED APPLICATIONS

This application claims the priority of Korean Patent Application No. 10-2012-0155772 filed on Dec. 28, 2012, in the Korean Intellectual Property Office, the disclosure of which is incorporated herein by reference.

### BACKGROUND OF THE INVENTION

1. Field of the Invention

The present invention relates to a dielectric composition having excellent electrical characteristics and a multilayer ceramic capacitor using the same.

2. Description of the Related Art

Generally, an electronic component using a ceramic material such as a capacitor, an inductor, a piezoelectric element, a varistor, a thermistor, or the like, includes a ceramic sintered body made of a ceramic material, internal electrodes formed within the ceramic sintered body, and external electrodes formed on a surface of the ceramic sintered body and connected to the internal electrodes.

Among ceramic electronic components, a multilayer ceramic capacitor includes a plurality of laminated dielectric layers, internal electrodes facing each other with the dielectric layers interposed therebetween, and external electrodes electrically connected to respective internal electrodes.

Multilayer ceramic capacitors have been widely used in computers, PDAs, mobile phones, and the like, due to advantages thereof such as miniaturization, high capacitance, ease of mounting, and the like.

Multilayer ceramic capacitors are generally manufactured by laminating ceramic sheets using a conductive paste for internal electrodes and a dielectric paste by a printing method and sintering the laminate.

Electrical characteristics of multilayer ceramic capacitors are varied according to types and properties of dielectric powder included in the dielectric paste.

Therefore, a dielectric composition having high dielectric permittivity and excellent high-temperature characteristics is required in order to manufacture a high-reliability multilayer ceramic capacitor.

### RELATED ART DOCUMENT

(Patent Document 1) Korean Patent Laid-Open Publication No. 2012-0089549

### SUMMARY OF THE INVENTION

An aspect of the present invention provides a dielectric composition having excellent electrical characteristics and a multilayer ceramic capacitor using the same.

According to an aspect of the present invention, there is provided a multilayer ceramic capacitor, including: a ceramic body including dielectric layers; first and second internal electrodes disposed to face each other with the dielectric layer interposed therebetween within the ceramic body; a first external electrode electrically connected to the first internal electrodes; and a second external electrode electrically connected to the second internal electrodes, wherein the dielectric layer includes 40 to 99 wt % of barium titanate (BaTiO₃) having an average grain size of 0.1 μm to 0.8 μm and 1 to 60 wt % of barium titanate zirconate (Ba(Ti₁₋ₓZrₓ)O₃) having an average grain size of 0.2 to 2.0 μm.

The dielectric layer may further include at least one first subcomponent selected from the group consisting of manganese (Mn), vanadium (V), chrome (Cr), iron (Fe), nickel (Ni), cobalt (Co), copper (Cu), and zinc (Zn).

The first subcomponent may be included in a content of 0.1 to 1 part by weight based on 100 parts by weight of a barium titanate-based base material composed of barium titanate (BaTiO₃) and barium titanate zirconate (Ba(Ti₁₋ₓZrₓ)O₃).

The dielectric layer may further include at least one second subcomponent selected from the group consisting of magnesium (Mg) and aluminum (Al).

The second subcomponent may be included in a content of 0.1 to 1 part by weight based on 100 parts by weight of a barium titanate-based base material composed of barium titanate (BaTiO₃) and barium titanate zirconate (Ba(Ti₁₋ₓZrₓ)O₃).

Here, a grain size distribution of dielectric grains included in the dielectric layer may satisfy 1.1≦D₁₀₀/D₁≦30, in which when 100 dielectric grains included in the dielectric layer are classified into 100 sizes, D₁₀₀ denotes a size of a hundredth grain having the largest grain size and D₁ denotes a size of a first grain having the smallest grain size.

According to another aspect of the present invention, there is provided a dielectric composition, including: 40 to 99 wt % of barium titanate (BaTiO₃) powder; and 1 to 60 wt % of barium titanate zirconate (Ba(Ti₁₋ₓZrₓ)O₃) powder.

The dielectric composition may further include at least one first subcomponent selected from the group consisting of manganese (Mn), vanadium (V), chrome (Cr), iron (Fe), nickel (Ni), cobalt (Co), copper (Cu), and zinc (Zn).

The first subcomponent may be included in a content of 0.1 to 1 part by weight based on 100 parts by weight of a barium titanate-based base material composed of barium titanate (BaTiO₃) and barium titanate zirconate (Ba(Ti₁₋ₓZrₓ)O₃).

The dielectric composition may further include at least one second subcomponent selected from the group consisting of magnesium (Mg) and aluminum (Al).

The second subcomponent may be included in a content of 0.1 to 1 part by weight based on 100 parts by weight of a barium titanate-based base material composed of barium titanate (BaTiO₃) and barium titanate zirconate (Ba(Ti₁₋ₓZrₓ)O₃).

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically showing a multilayer ceramic capacitor according to an embodiment of the present invention;

FIG. 2 is a cross-sectional view taken along line A-A′ of FIG. 1;

FIGS. 3A to 3D are graphs showing high-temperature degradation characteristics of multilayer ceramic capacitors according to a mixture ratio of barium titanate and barium titanate zirconate; and

FIGS. 4A to 4F are scanning electron microscope (SEM) images showing microstructures of dielectric layers according to a mixture ratio of barium titanate and barium titanate zirconate.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like elements.

Hereinafter, a dielectric composition and a multilayer ceramic capacitor using the same according to embodiments of the present invention will be described with reference to the accompanying drawings.

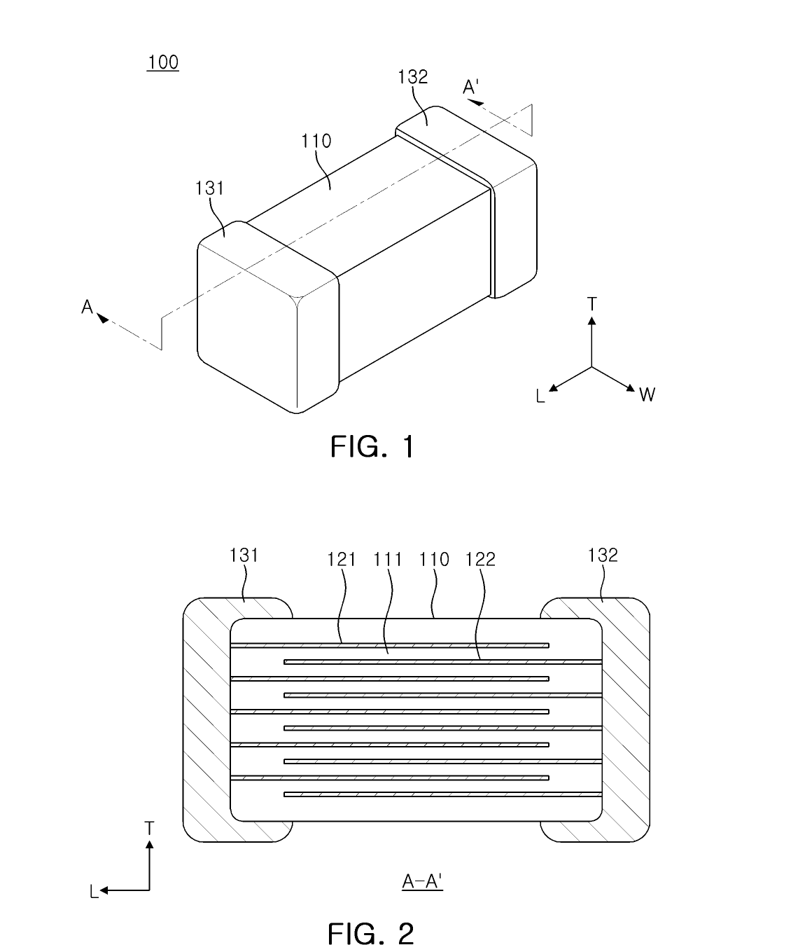

FIG. 1 is a perspective view schematically showing a multilayer ceramic capacitor according to an embodiment of the present invention.

FIG. 2 is a cross-sectional view taken along line A-A′ of FIG. 1.

Referring to FIGS. 1 and 2, a multilayer ceramic capacitor 100 according to an embodiment of the present invention may include a ceramic body 110 and first and second external electrodes 131 and 132.

The shape of the ceramic body 110 is not particularly limited, but the ceramic body 110 may have a hexahedral shape, as shown in FIG. 1. The ceramic body 110 may not have a hexahedral shape having entirely parallel lines due to shrinkage of a ceramic powder at the time of sintering, but may have a substantially hexahedral shape.

As shown in FIG. 2, which is an exploded perspective view of the ceramic body 110, the ceramic body 110 may include a plurality of dielectric layers 111 and first and second internal electrodes 121 and 122 formed on the dielectric layers 111, respectively. The plurality of dielectric layers having the internal electrodes formed thereon may be laminated in the ceramic body 110. In addition, the first and second internal electrodes 121 and 122 may face each other having each of the dielectric layers 111 interposed therebetween.

According to the embodiment of the invention, the plurality of dielectric layers 111, constituting the ceramic body 110, are in a sintered state, and may be integrated such that boundaries between adjacent dielectric layers may not be readily apparent.

The dielectric layer 111 may be formed of a dielectric composition including barium titanate (BaTiO₃) and barium titanate zirconate (Ba(Ti₁₋ₓZrₓ)O₃).

Barium titanate zirconate, in which zirconium is added to B-site (Ti site) of barium titanate, has increased dielectric permittivity at a curie temperature as compared with pure barium titanate, and is effective in increasing the dielectric permittivity since a curie temperature tends to be shifted to a low temperature. In addition, the addition of zirconium results in increasing band gap energy, and thus insulation characteristics may be improved under the same grain size conditions. However, barium titanate zirconate may cause increased grain growth, as compared with pure barium titanate, at the same sintering temperature, so that degradation in temperature coefficient of capacitance (TCC characteristics) and DC-bias characteristics and a decrease in the number of grains per layer due to relatively large crystal grains may deteriorate reliability.

Therefore, in order to address the foregoing defects, the ceramic powder according to the embodiment of the present invention may include 40 to 99 wt % of barium titanate and 1 to 60 wt % of barium titanate zirconate.

In the case in which the content of barium titanate zirconate is below 1 wt %, an effect of improving the dielectric permittivity may not be exhibited. In the case in which the content of barium titanate zirconate is above 60 wt %, an effect of suppressing mobility of charge carriers may not be apparent due to excessive grain growth, resulting in deterioration in insulation characteristics. Therefore, in the case in which a mixture ratio of barium titanate and barium titanate zirconate is 40 to 99 wt % of barium titanate to 1 to 60 wt % of barium titanate zirconate, a dielectric composition having increased dielectric permittivity and improved insulation characteristics may be obtained.

The dielectric composition according to the embodiment of the present invention may further include, as a first subcomponent, at least one variable valence acceptor element selected from the group consisting of manganese (Mn), vanadium (V), chrome (Cr), iron (Fe), nickel (Ni), cobalt (Co), copper (Cu), and zinc (Zn). The variable valence acceptor element may be included in a content of 0.1 to 1 part by weight based on 100 parts by weight of a barium titanate-based base material composed of barium titanate and barium titanate zirconate.

In the case in which the content of the variable valence acceptor element is below 0.1 part by weight, resistance to reduction and reliability may be deteriorated. In the case in which the content of the variable valence acceptor element is above 1 part by weight, side effects such as an increase in sintering temperature and a deterioration in capacitance may occur.

In addition, the dielectric composition according to the embodiment of the present invention may further include, as a second subcomponent, at least one fixed valence acceptor element selected from the group consisting of manganese (Mn) and aluminum (Al). The fixed valence acceptor element may be included in a content of 0.1 to 1 part by weight based on 100 parts by weight of a barium titanate-based base material composed of barium titanate and barium titanate zirconate.

In the case in which the content of the fixed valence acceptor element is below 0.1 part by weight, resistance to reduction and reliability may be deteriorated. In the case in which the content of the fixed valence acceptor element is above 1 part by weight, a sintering temperature and an aging rate may be increased.

The first and second subcomponents may be included in the form of an oxide or a carbonate of the variable valence acceptor element and the fixed valence acceptor element.

Further, in order to realize desired characteristics the dielectric composition may further include an additive such as an element selected from the group consisting of cesium (Ce), niobium (Nb), lanthanum (La), antimony (Sb), silicon (Si), barium (Ba), calcium (Ca), and aluminum (Al), an oxide or a carbonate thereof, or a mixture thereof.

The dielectric layers may be formed by sintering ceramic green sheets including the foregoing dielectric composition, a solvent, and an organic binder.

According to the embodiment of the present invention, the first and second internal electrodes may be formed of a conductive paste including a conductive metal. The conductive metal may be nickel (Ni), copper (Cu), palladium (Pd), or an alloy thereof, but is not limited thereto.

In addition, the internal electrodes may be printed on the ceramic green sheets forming the dielectric layers using the conductive paste by a printing method such as a screen printing method or a gravure printing method, without being limited thereto. The ceramic green sheets having the internal electrodes printed thereon may be alternately laminated and sintered to thereby form the ceramic body 110.

Then, the first and second external electrodes 131 and 132 are formed to be electrically connected to the first and second internal electrodes. The first and second external electrodes 131 and 132 may include a conductive metal, and the conductive metal may be, but is not limited to, nickel (Ni), copper (Cu), tin (Sn), or an alloy thereof.

The dielectric layer 111 of the multilayer ceramic capacitor 100 manufactured by the foregoing method may include 40 to 99 wt % of barium titanate (BaTiO₃) and 1 to 60 wt % of barium titanate zirconate (Ba(Ti₁₋ₓZrₓ)O₃). The barium titanate may have an average grain size of 0.1 μm to 0.8 μm, and the barium titanate zirconate may have an average grain size of 0.2 μm to 2.0 μm. In the case in which the average grain size of barium titanate is below 0.1 μm, sufficient grain growth may not occur due to non-sintering, and thus dielectric permittivity may be very low and a dielectric loss factor (DF) may be increased. In the case in which the average grain size of the barium titanate is above 0.8 μm, dielectric permittivity may be increased, but reliability may be deteriorated and TCC and DC-bias characteristics may also be deteriorated.

In addition, in the case in which the average grain size of the barium titanate zirconate is below 0.2 μm, sufficient grain growth may not occur, and thus dielectric permittivity may be very low and the dielectric loss factor (DF) may be increased. In the case in which the average grain size of the barium titanate zirconate is above 2.4 μm, reliability and TCC and DC-bias characteristics may be decreased.

The dielectric layer 111 may further include at least one first subcomponent selected from the group consisting of manganese (Mn), vanadium (V), chrome (Cr), iron (Fe), nickel (Ni), cobalt (Co), copper (Cu), and zinc (Zn). The first subcomponent may be included in a content of 0.1 to 1 part by weight based on 100 parts by weight of the barium titanate-based base material composed of barium titanate (BaTiO₃) and barium titanate zirconate (Ba(Ti₁₋ₓZrₓ)O₃).

The dielectric layer 111 may further include at least one second subcomponent selected from the group consisting of manganese (Mg) and aluminum (Al). The second subcomponent may be included in a content of 0.1 to 1 part by weight based on 100 parts by weight of the barium titanate-based base material composed of barium titanate (BaTiO₃) and barium titanate zirconate (Ba (Ti₁₋ₓZrₓ)O₃).

Hereinafter, a description overlapped with the above-described dielectric composition association with the multilayer ceramic capacitor according to the embodiment of the present invention will be omitted in order to avoid repeated explanations.

The grain size distribution of dielectric grains included in the dielectric layer may satisfy 1.1≦D₁₀₀/D₁≦30. When, after sintering, 100 dielectric grains included in the dielectric layer 111 are classified into 100 sizes and then arranged, D₁₀₀ denotes a size of the hundredth grain, which has the largest grain size, and D₁ denotes a size of the first grain, which has the smallest grain size. That is, a high-reliability multilayer ceramic capacitor can be obtained by allowing the size difference between the largest grain and the smallest grain not to exceed 30 times.

In the embodiment of the present invention, barium titanate is mixed with barium titanate zirconate having high dielectric properties, to thereby control degradation in electrical characteristics and reliability of the multilayer ceramic capacitor. In other words, barium titanate having a small degree of grain growth is mixed with barium titanate zirconate capable of securing high dielectric properties, to thereby realize high dielectric properties and suppress generation of excessive crystal grains, so that degradation in reliability, TCC characteristics, and DC-bias characteristics can be prevented.

### Experimental Example

Ceramic sheets were prepared by mixing barium titanate and barium titanate zirconate doped with 5 moles of zirconium and then stirring the mixture together with a dispersant, using ethanol and toluene as a solvent.

Upper and lower covers were formed by laminating 10˜15 μm thickness-cover sheets in 30 layers, and an active layer was formed by laminating 3˜5 μm thickness-sheets having nickel (Ni) internal electrodes respectively printed thereon in 20 layers, thereby preparing a chip having a size of 3.2 mm×1.6 mm (3216 size). The chip was subjected to a plasticizing process for debindering, a sintering process at 1100 □ for 1 hour, and a termination process, and then electrical characteristics of the chip were measured.

Table 1 below shows electrical characteristics of multilayer ceramic capacitors according to the mixing ratios of barium titanate (represented by ET) and barium titanate zirconate (represented by BTZ).

TABLE 1

| | |
|---|---|
| Mixing ratio | Dielectric |

| Sample | BT | BTZ | Permittivity | STEP-IR |
|---|---|---|---|---|
| 1* | 100 | 0 | 3225 | ∘ |
| 2* | 99.6 | 0.4 | 3226 | ∘ |
| 3* | 99.2 | 0.8 | 3248 | ∘ |
| 4 | 99 | 1 | 3310 | ∘ |
| 5 | 90 | 10 | 3485 | ∘ |
| 6 | 80 | 20 | 3526 | ∘ |
| 7 | 60 | 40 | 3668 | ∘ |
| 8 | 50 | 50 | 3648 | ∘ |
| 9 | 40 | 60 | 4017 | ∘ |
| 10* | 38 | 62 | 4542 | x |
| 11* | 35 | 65 | 4668 | x |
| 12* | 30 | 70 | 4687 | x |
| 13* | 20 | 80 | 4723 | x |
| 14* | 0 | 100 | 4408 | x |

*Comparative Example

The term STEP-IR represents high-temperature degradation behavior evaluation. The determination criterion was set such that when a direct voltage of 1V/μm per 1 minute was raised at a relatively high temperature of 150□, a case in which degradation did not occur for 35 minutes or longer is marked by “∘”, while a case in which degradation occurred within 35 minutes is marked by “X”.

In the case in which the content of barium titanate zirconate is below 1 wt %, an effect of increasing dielectric permittivity was insignificant, but the dielectric permittivity was increased for the mixture composition of lwt % or more of barium titanate zirconate. However, it may be seen that in the case in which the content of barium titanate zirconate is above 60 wt %, chip degradation occurred.

Pure barium titanate zirconate has higher band gap energy than pure barium titanate, and thus is advantageous in view of insulation characteristics. However, the barium titanate zirconate has a large degree of grain growth, and thus is disadvantageous in view of an effect of suppressing mobility of charge carriers due to grain boundaries, resulting in inferiority in insulation characteristics at a high temperature.

However, as shown in Samples 4 to 9 of Table 1, it may be seen that when the mixture ratio was in the range of 40 to 99 wt % of barium titanate (BaTiO₃) and 1 to 60 wt % of barium titanate zirconate (Ba(Ti₁₋ₓZrₓ)O₃), dielectric permittivity was improved and high-temperature insulation characteristics was also secured.

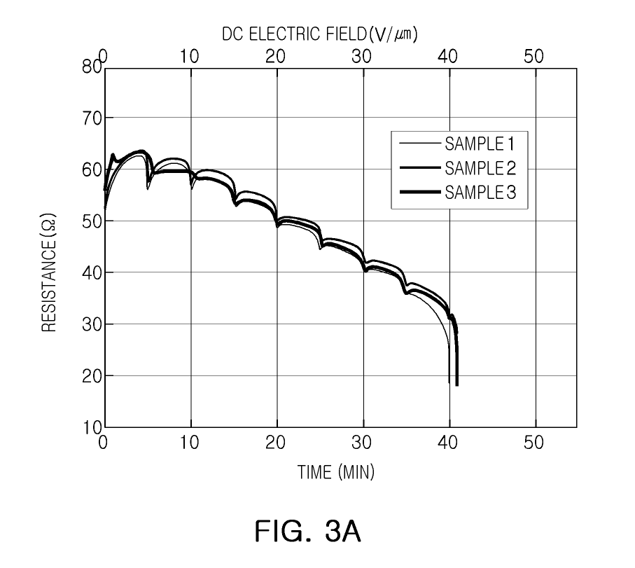

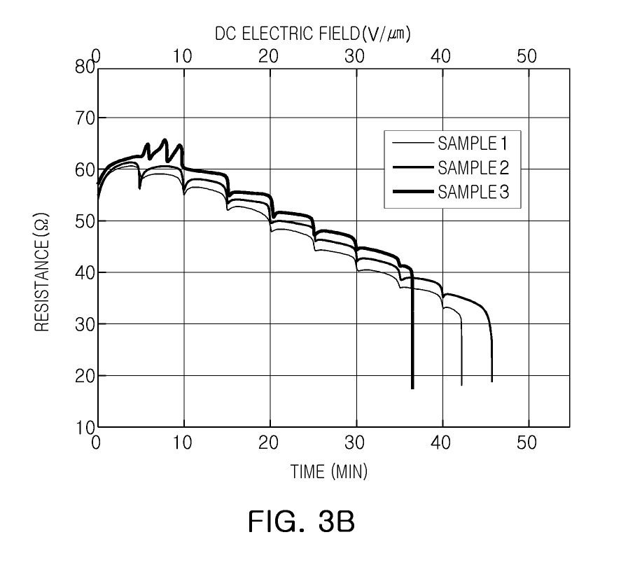

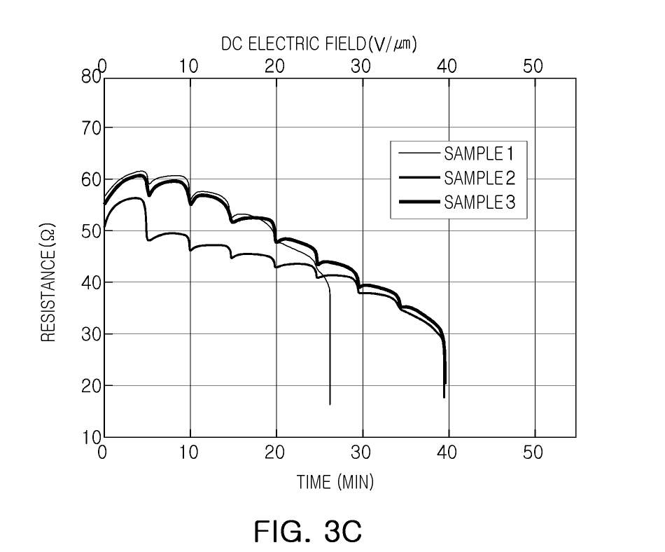

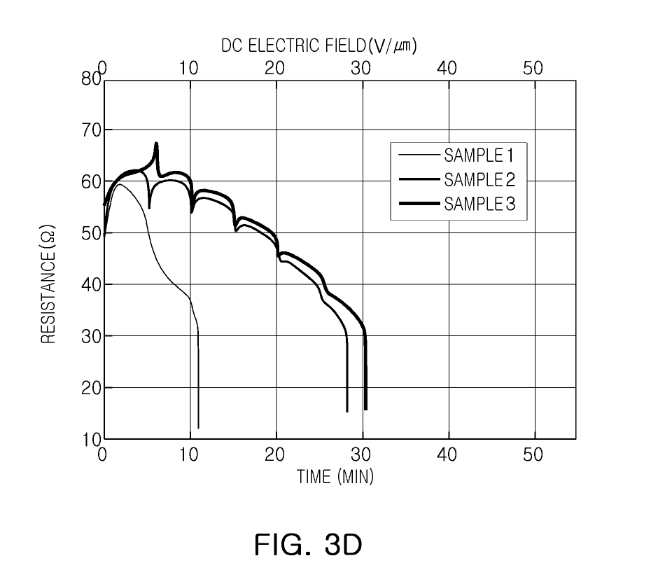

FIGS. 3A to 3D are graphs showing high-temperature degradation characteristics of multilayer ceramic capacitors according to a mixture ratio of barium titanate and barium titanate zirconate. Specifically, FIG. 3A shows samples having 100 wt % of barium titanate; FIG. 3B shows samples having a mixture ratio of 60 wt % of barium titanate and 40 wt % of barium titanatezirconate; FIG. 3C shows samples having a mixture ratio of 40 wt % of barium titanate and 60 wt % of barium titanate zirconate; and FIG. 3D shows samples having 100 wt % of barium titanate zirconate.

As shown in FIGS. 3A to 3D, it may be seen that when the content of barium titanate zirconate was 60 wt % or less, high-temperature insulation characteristics was improved.

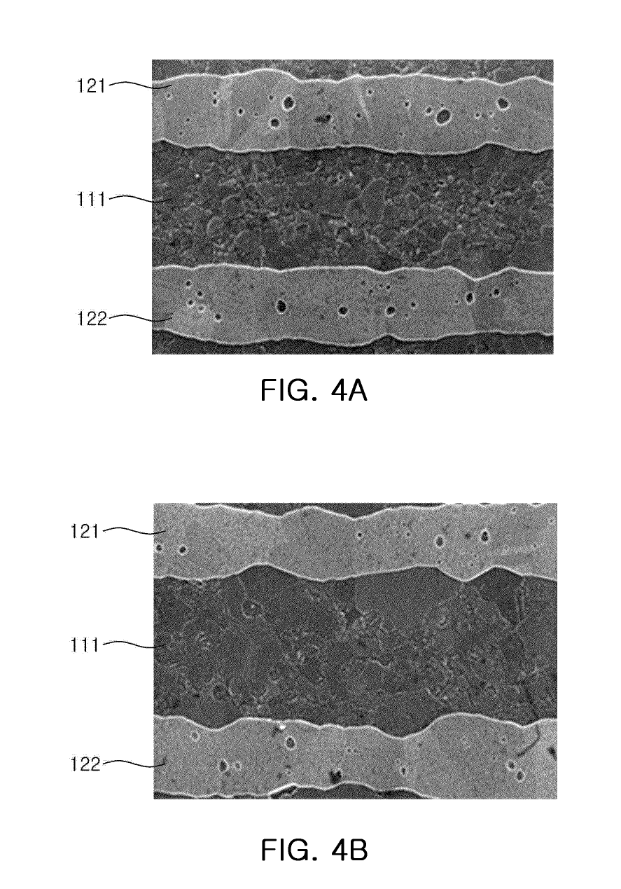

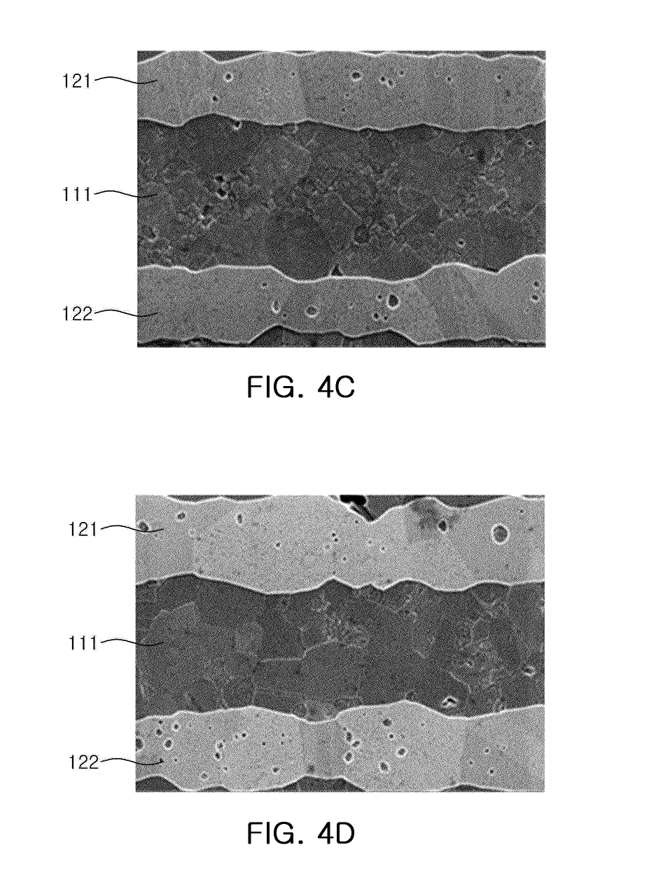

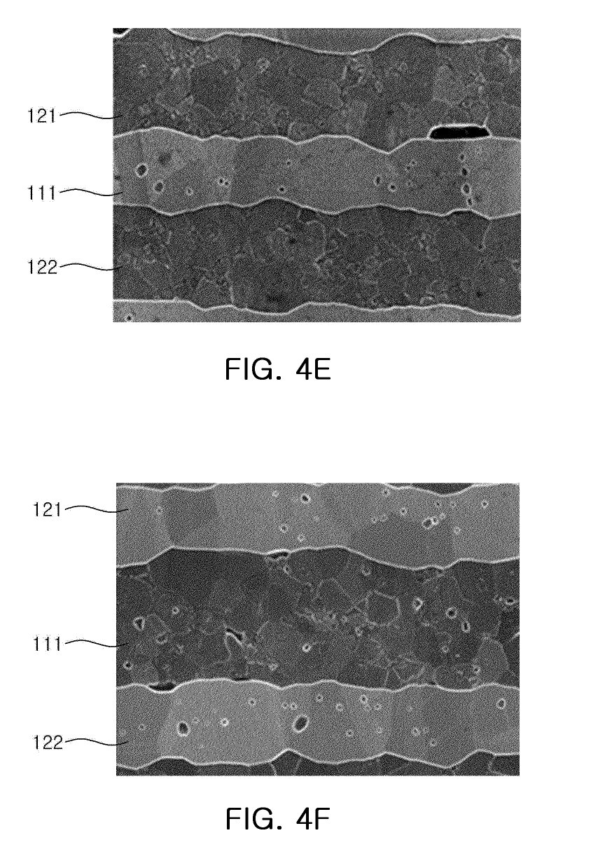

FIGS. 4A to 4F are scanning electron microscope (SEM) images showing microstructures of dielectric layers according to a mixture ratio of barium titanate and barium titanate zirconate. Specifically, FIG. 4A shows dielectric layers having 100 wt % of barium titanate; FIG. 4B shows dielectric layers having a mixture ratio of 60 wt % of barium titanate and 40 wt % of barium titanate zirconate; FIG. 4C shows dielectric layers having a mixture ratio of 50 wt % of barium titanate and 50 wt % of barium titanate zirconate; FIG. 4D shows dielectric layers having a mixture ratio of 60 wt % of barium titanate and 40 wt % of barium titanate zirconate; FIG. 4E shows dielectric layers having a mixture ratio of 20 wt % of barium titanate and 80 wt % of barium titanate zirconate; and FIG. 4F shows dielectric layers having 100 wt % of barium titanate zircon.

As shown in FIGS. 4A to 4F, it may be seen that when the content of barium titanate zirconate was above 60 wt %, many large coarse grains are included in the dielectric layer since barium titanate has a limit in controlling grain growth.

Therefore, it may be seen that the mixture ratio of barium titanate and barium titanate zirconate need to satisfy a range of 40 to 99 wt % of barium titanate and 1 to 60 wt % of barium titanate zirconate considering reliability according to capacitance, high-temperature degradation characteristics, microstructure, and the like.

As set forth above, according to embodiments of the present invention, a high-capacitance and high-reliability multilayer ceramic capacitor can be manufactured by mixing barium titanate and barium titanate zirconate at a predetermined ratio as a ceramic base material powder.

While the present invention has been shown and described in connection with the embodiments, it will be apparent to those skilled in the art that modifications and variations can be made without departing from the spirit and scope of the invention as defined by the appended claims.

What is claimed is:

1. A multilayer ceramic capacitor, comprising:
a ceramic body including dielectric layers;
first and second internal electrodes disposed to face each other with the dielectric layer interposed therebetween within the ceramic body;
a first external electrode electrically connected to the first internal electrodes; and
a second external electrode electrically connected to the second internal electrodes,
wherein the dielectric layer includes 40 to 99 wt % of barium titanate (BaTiO₃) having an average grain size of 0.1 μm to 0.8 μm and 1 to 60 wt % of barium titanate zirconate (Ba (Ti₁₋ₓZrₓ)O₃) having an average grain size of 0.2 to 2.0 μm.

2. The heat radiant paint composition of claim 1, wherein the dielectric layer further includes at least one first subcomponent selected from the group consisting of manganese (Mn), vanadium (V), chrome (Cr), iron (Fe), nickel (Ni), cobalt (Co), copper (Cu), and zinc (Zn).

3. The heat radiant paint composition of claim 2, wherein the first subcomponent is included in a content of 0.1 to 1 part by weight based on 100 parts by weight of a barium titanate-based base material composed of barium titanate (BaTiO₃) and barium titanate zirconate (Ba(Ti₁₋ₓZrₓ)O₃).

4. The heat radiant paint composition of claim 1, wherein the dielectric layer further includes at least one second subcomponent selected from the group consisting of magnesium (Mg) and aluminum (Al).

5. The heat radiant paint composition of claim 4, wherein the second subcomponent is included in a content of 0.1 to 1 part by weight based on 100 parts by weight of a barium titanate-based base material composed of barium titanate (BaTiO₃) and barium titanate zirconate (Ba(Ti₁₋ₓZrₓ)O₃).

6. The heat radiant paint composition of claim 1, wherein a grain size distribution of dielectric grains included in the dielectric layer satisfies 1.1≦D₁₀₀/D₁≦30, in which when 100 dielectric grains included in the dielectric layer are classified into 100 sizes, D₁₀₀ denotes a size of a hundredth grain having the largest grain size and D₁ denotes a size of a first grain having the smallest grain size.

7. A dielectric composition, comprising:
40 to 99 wt % of barium titanate (BaTiO₃); and
1 to 60 wt % of barium titanate zirconate (Ba (Ti₁₋ₓZrₓ)O₃).

8. The dielectric composition of claim 7, further comprising at least one first subcomponent selected from the group consisting of manganese (Mn), vanadium (V), chrome (Cr), iron (Fe), nickel (Ni), cobalt (Co), copper (Cu), and zinc (Zn).

9. The dielectric composition of claim 8, wherein the first subcomponent is included in a content of 0.1 to 1 part by weight based on 100 parts by weight of a barium titanate-based base material composed of barium titanate (BaTiO₃) and barium titanate zirconate (Ba(Ti₁₋ₓZrₓ)O₃).

10. The dielectric composition of claim 7, further comprising at least one second subcomponent selected from the group consisting of magnesium (Mg) and aluminum (Al).

11. The dielectric composition of claim 10, wherein the second subcomponent is included in a content of 0.1 to 1 part by weight based on 100 parts by weight of a barium titanate-based base material composed of barium titanate (BaTiO₃) and barium titanate zirconate (Ba(Ti₁₋ₓZrₓ)O₃).
